(19) United States
(12) Patent Application Publication
(10) Pub. No.: US 2009/0302761 A1
(43) Pub. Date: Dec. 10, 2009

(54) DISCHARGE LAMP COMPRISING A DISCHARGE VESSEL AND AN ELECTRODE FRAME

(75) Inventors: Gerald Hammer, Konigsbrunn (DE); Alfred Langer, Kissing (DE); Thomas Noll, Kipfenberg (DE); Klaus Pankratz, Freihalden (DE)

Correspondence Address: FRISHAUF, HOLTZ, GOODMAN & CHICK, PC, 220 Fifth Avenue, 16TH Floor, NEW YORK, NY, 10001-7708, US

(73) Assignee: OSRAM GESELLSCHAFT MIT BESCHRANKTER HAFTUNG, Munchen (DE)

(21) Appl. No.: 12/312,316

(22) PCT Filed: Nov. 6, 2007
(86) PCT No.: PCT/EP2007/061918

§ 371 Date: May 5, 2009

(30) Foreign Application Priority Data
Nov. 9, 2006 (DE) 10 2006 052 952.9

(51) Int. Cl. H01K 1/50

(52) U.S. Cl. 313/578

(57) ABSTRACT

The invention relates to a discharge lamp comprising a discharge vessel (2) and an electrode frame (3) which is provided with a lamp coil (33) and at least some sections of which extend into the discharge vessel (2). Electrode holders (31, 32) are connected to a glass bead (34), at least some areas of which are sealed into an end region (21) of the discharge vessel (2).

### TECHNICAL FIELD

The invention relates to a discharge lamp comprising a discharge vessel and an electrode frame with a lamp filament, which electrode frame extends at least partially into the discharge vessel, and electrode holders are connected to a glass bead.

### PRIOR ART

DE 10 2004 004 655 A1 discloses a low-pressure discharge lamp in which an electrode frame extends through an end region of a discharge vessel into the discharge space. Electrode holders of the electrode frame are sealed in a gas-tight fashion at an end region of the discharge vessel, and a glass bead that is located inside the discharge vessel is arranged between the electrode holders.

Moreover, FIG. 1 shows a similarly constructed low-pressure discharge lamp 1, which has a discharge vessel 2 into which an electrode frame 3 extends partially. Electrode holders 31 and 32 of the electrode frame 3 are sealed in a gas-tight fashion in the end region 21, in which the discharge vessel 2 is pinched. A lamp filament 33 is arranged as electrode at a front end of the electrode frame 3. A glass bead 34 that extends between the two electrode holders 31 and 32 is also fitted inside the discharge vessel 2, in a fashion set back from this lamp filament 33. Furthermore, a material region 35 made from TiH₂ is formed on the side of this glass bead 34 facing the end region 21. In the so-called end of life state of the discharge lamp 1, in which it is possible in the broken state of the lamp filament 33 for one of the electrode holders 31 or 32 to melt back, thus producing a temperature increase, the hydrogen in the material region 35 evaporates, and this can prevent further critical operation of the discharge lamp 1 with regard to damage or destruction. In particular, thermal destruction of the plastic housing can thereby be avoided.

The structure known from the prior art is relatively complicated to produce and therefore also cost-intensive.

### SUMMARY OF THE INVENTION

It is an object of the present invention to provide a discharge lamp that can be implemented in conjunction with the same operational reliability with less outlay and more cost-effectively.

This object is achieved by a discharge lamp that has the features as claimed in patent claim 1.

An inventive discharge lamp comprises a discharge vessel and an electrode frame on which a lamp filament is arranged as electrode. The electrode frame extends partially into the discharge vessel, and electrode holders of this electrode frame are connected to a glass bead. The glass bead serves to increase the stability of the electrode frame. This glass bead is sealed or pinched at least partially into an end region of the discharge vessel. The discharge lamp can thereby be produced with less outlay, and costs can be spared in the material and in the production.

Owing to the at least partial introduction of the glass bead into the pinched end region, it is also possible to increase the tightness at this end region, since the tightness between glass/glass transitions is better than between glass and electrode holders.

The glass bead is preferably completely sealed in the end region. In addition to an arrangement that minimizes installation space, it is thereby also possible to further improve the tightness in the end region.

Owing to the at least partial sealing of the glass bead in the end region it is also possible for the electrode frame to project into the discharge space of the discharge vessel with a length that is shortened by comparison with the prior art. Consequently, the discharge space of the discharge lamp can be increased and/or the overall length of the lamp can be reduced.

The glass material of the end region preferably differs from the glass material of the glass bead. Two different glass materials are then sealed in the end region.

The coefficients of thermal expansion of the two glass materials preferably differ in such a way that upon the occurrence of temperature gradients in the region of the two glass materials mechanical stresses arise that lead to a crack in the pinched region or in an end region of the discharge vessel.

Such a glass pairing in a lamp region where high temperature gradients can occur constitutes a safeguard against further destruction of components of the system.

Particularly in the so-called end of life behavior of the discharge lamp, more reliable crack can thereby be produced in the glass, since, because of the rising temperature and the different coefficients of expansion, different stress relationships are thereby produced, and so it is possible to produce a fissure in the glass, particularly in said temperature range.

However, it is also possible to provide that the glass material of the end region is the same as the glass material of the glass bead. Such a formation of materials enables a particularly favorable formation of tightness in the seal region. Soft glass is preferably used here as glass material.

The height of the end region is preferably smaller than twice the maximum height of the glass bead. This configuration permits the discharge lamp to be formed with optimized installation space, adequate tightness and in a mechanically stable fashion.

The glass material of the glass bead can also be processed more easily because of the invention. Moreover, it is also possible to achieve cost advantages through the use of more favorable materials, in particular more favorable glass material.

### BRIEF DESCRIPTION OF THE DRAWING(S)

An exemplary embodiment of the invention is explained in more detail below with the aid of schematics. In the drawing:

FIG. 1 shows a schematic of a subregion of a discharge lamp known from the prior art; and

FIG. 2 shows a schematic of a subregion of an inventive discharge lamp.

### PREFERRED DESIGN OF THE INVENTION

Identical or functionally identical elements are provided with the same reference symbols in the figures.

A discharge lamp 1 designed as a low-pressure discharge lamp comprises a tubular discharge vessel 2 with a lower end region 21 that is of pinched design. An electrode frame 3 extends partially into the discharge vessel 2 and comprises two wire-shaped electrode holders 31 and 32. A lamp filament 33 is arranged on a front end, arranged in the discharge vessel 2, of these two electrode holders 31 and 32 as electrode. A glass bead 34 extends between the two electrode holders 31 and 32 and, in the exemplary embodiment, is completely pinched into the end region 21. The glass material of the end region 21 differs in the exemplary embodiment from the glass material of the glass bead 34. In particular, the two glass materials are designed such that their coefficients of thermal expansion differ in such a way that, upon the occurrence of temperature gradients in a temperature range with, for example, local temperatures between 250° C. and 500° C., the different expansion leads to a crack in the end region 21.

In the exemplary embodiment, the sealing of the electrode holders 31 and 32 into the glass bead 34 is performed in a vacuum-tight fashion.

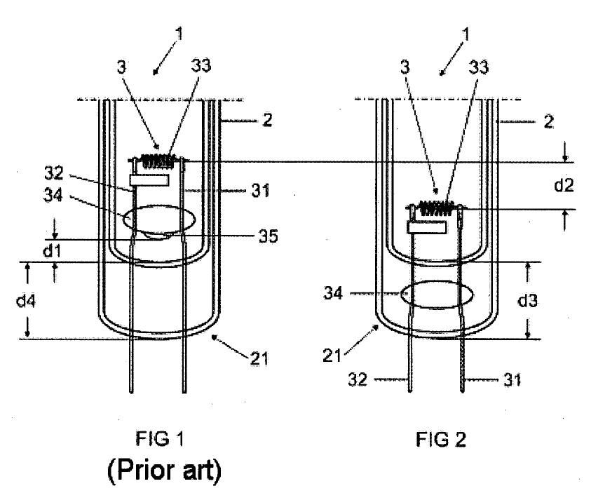

Owing to the improved sealing behavior in the end region 21 because of the glass bead 34 sealed completely therein, it is also possible to reduce the height d3 of the pinched end region 21 by comparison with the height d4 of the end region 21 in the prior art in accordance with FIG. 1. In the exemplary embodiment, the height h3 is 1.5 times the maximum height, formed approximately in the middle, of the glass bead 34, which is of oval cross section.

Moreover, in accordance with the inventive discharge lamp 1 in FIG. 2, the electrode frame 3 extends by a height d2 less far into the discharge vessel 2 than is rendered necessary by the electrode frame 3 in the known discharge lamp in accordance with FIG. 1.

1. A discharge lamp comprising a discharge vessel (2) and an electrode frame (3) with a lamp filament (33), which electrode frame (3) extends at least partially into the discharge vessel (2), and electrode holders (31, 32) of the electrode frame (3) are connected to a glass bead (34), characterized in that the glass bead (34) is sealed at least partially in an end region (21) of the discharge vessel (2).

2. The discharge lamp as claimed in claim 1, characterized in that the glass bead (34) is completely sealed in the pinched end region (21).

3. The discharge lamp as claimed in claim 1 or 2, characterized in that the glass material of the end region (21) differs from the glass material of the glass bead (34).

4. The discharge lamp as claimed in claim 3, characterized in that the coefficients of thermal expansion of the two glass materials differ in such a way that a crack can be produced in the glass in the end region (21) upon the occurrence of temperature gradients of greater than 50° C. between the glass bead (34) and the glass material of the end region (21).

5. The discharge lamp as claimed in claim 1 or 2, characterized in that the glass material of the end region (21) is the same as the glass material of the glass bead (34).

6. The discharge lamp as claimed in claim 5, characterized in that the glass material is soft glass.

7. The discharge lamp as claimed in claim 1 or 2, characterized in that the electrode holders (31, 32) are sealed vacuum-tight into the glass bead (34).

8. The discharge lamp as claimed in claim 1 or 2, characterized in that the height (d3) of the end region (21) is smaller than twice the maximum height of the glass bead (34).
